(19) United States
(12) Patent Application Publication
(10) Pub. No.: US 2005/0013140 A1
(43) Pub. Date: Jan. 20, 2005

(54) Original equipment automotive elongated side marker lights

(76) Inventor: Joseph Edward Currie, Webster, NH (US)

Correspondence Address: JOSEPH E. CURRIE, 506 WHITE PLAINS RD., WEBSTER, NH, 03303-7112, US

(21) Appl. No.: 10/621,217

(22) Filed: Jul. 17, 2003

(51) Int. Cl. B60Q 1/24

(52) U.S. Cl. 362/495

(57) ABSTRACT

A new automotive sidelight designed specifically for automotive original equipment manufacturers is disclosed. This new elongated sidelight is constructed by inserting at least one multiple light emitting diode board, with at least one reflective surface, into an injection mold that also forms illumination diffusion grooves on at least one surface. The LED mounting board can have multiple colors of LEDs on each side, so that this sidelight can be multi-purpose. A diagonal reflective surface extending almost from end to end can also be inserted into the mold. At least one injection molded UV resistant polycarbonate cover section is ultrasonically welded to the insertion-molded section. This sidelight is designed to mount either between double paneled vehicle sides or behind single panel vehicle sides. A double-sided embodiment of this sidelight, mounted into a pickup truck bed wall, functions as a sidelight, and illuminates the cargo area.

### CROSS-REFERENCE TO RELATED APPLICATIONS

(Not applicable)

### STATEMENT REGARDING FEDERALLY SPONSORED RESEARCH OR DEVELOPMENT

(Not Applicable)

### BACKGROUND OF INVENTION

This invention relates to an automotive side marker lighting system and more particularly to original equipment manufactured side marker lighting.

There have been many innovative examples of new automotive lighting that both increase automotive safety and enhance the decorative appeal of automotive vehicles. Most new examples of automotive lighting are intended for use as aftermarket add-ons, although some of the new conceptual lighting could be modified and installed as original equipment lighting.

This instant invention seeks too present to the automotive industry a new and unique side-marker light, and a new installation method and location for this new side-marker light that will both increases vehicle safety, utility, and add greatly to the decorative appeal of a vehicle.

Many examples of automotive lighting can be cited that seek to increase automotive safety and or enhance the visual appeal of a vehicle

In U.S. Pat. No. 4,831,503 issued May 16, 1989 to DeSantis, disclosure is made of a modular rear deck lighting cluster that fits across the rear of a vehicle body with incorporated light assemblies that include all required rear vehicle lighting.
a. In U.S. Pat. No. 5,400,225 issued to Currie on Mar. 21, 1995 an optical fiber illumination device disposed about the periphery of a motor vehicle rear window that cooperates with the vehicle lighting system is disclosed.
b. Mouzas, in U.S. Pat. No. 5,428,512 issued Jun. 27, 1995 discloses a vehicle side lighting arrangement that is actuated by the combination of a steering wheel turn sensor and activation of the turn indicator to provide notice to other drivers of the cornering condition of the vehicle.
c. U.S. Pat. No. 5,495,400 issued to Currie on Feb. 27, 1996 discloses an optical fiber illumination device that functions as illuminated pick up truck bed rails that cooperate with the vehicle lighting system.
d. Powell, et al. in U.S. Pat. No. 5,682,138 issued Oct. 28, 1997 discloses illuminating the rear wheel assembly of a wheeled vehicle for a period of time in response to a turn signal.
e. U.S. Pat. No. 5,826,965 issued on Oct. 27, 1998 to Lyons discloses a modular vehicular light bar comprising a plurality of light modules affixed to a tubular mounting rail and used as clearance lamps or warning lights.
f. Foerstner, et al. in U.S. Pat. No. 5,984,497 issued Nov. 16, 1999 discloses a light source directed into a multiple light guiding element with a light permeable cover to form a side marker light that emits light from the ends of the light guiding elements.
g. U.S. Pat. No. 6,114,954 issued to Palett et al. on Sep. 5, 2000 discloses an illuminated roof/luggage rack for automobiles and other vehicles that incorporates turn signal indicators and or sidelights.
h. U.S. Pat. No. 6,118,372 issued on Sep. 12, 2000 to Leow describes a passenger car sidelight mounted below and between the front and rear doors that is activated during low ambient light conditions when one of four secondary conditions is met.
i. Ramsey, in U.S. Pat. No. 4,985,810 issued Jan. 15, 991 discloses a running board assembly that features both functional and decorative lighting and is attached to the underside of specially designed automotive running boards.
j. Murphy, et al. in U.S. Pat. No. 6,565,244 issued on may 20, 2003 discloses a single source identification light bar for installation across the back of vehicles over eighty inches in width.
k. Lewis, et al. in U.S. Pat. No. 5,152,599 issued Oct. 6, 1992 discloses a contact strip attached to a truck body by adhesive material incorporating electrical conductivity within the electrically insulating contact stripe with multiple socket and bulb clearance lights attached thereto.
l. Eidelman discloses in U.S. Pat. No. 5,255,164 issued Oct. 19, 1993 a safety light marker system for a vehicle comprising two parallel elongated fixtures mounted on the roof of a vehicle, substantially along the entire length thereof, disposed close to and parallel to the left and right edges of said roof. Each of said fixtures including at least one light source adapted to provide illumination along the entire length of each of said fixtures and at least one light source of each fixture being connected to said vehicle electric signaling system. One or more light sources is provided at the sides and/or at on the roof of the vehicle. These light sources will be constructed in the form of elongated light clusters, or several single light sources that will demarcate a vehicle at night. Said light clusters, or number of single multi-function rare gas indicator bulbs, are installed on the tops and sides of a motor vehicle. In addition the elongated light sources and light clusters provide the following signalling functions: parking lights, backup lights, brake lights, left and right turn indicator lights, and emergency flasher lights. Said elongated cluster light sources are connected to the vehicle signaling and electric circuits in known ways.

None of the above inventions and patents, taken either singly or in combination, is seen to describe the instant invention as claimed.

### SUMMARY OF THE INVENTION

The present invention is a new technology side marker light for all types of motor vehicles. This new and unique side marker light is created and designed to be mounted recessed into a vehicle side panel, and to conform to the outside contour of the vehicle side panel, rather than be mounted onto the out-side of a vehicle.

The objective of this new invention is the advancement of the art of forming side marker lights using a combination of optically conductive acrylic or other plastic, light emitting diodes in several different configurations, (herein after LEDs), insertion plastic injection molding, injection molding, and ultrasonic welding.

A first component of a first embodiment of this new technology side marker lighting is formed by an insertion injection molding process. A reflective surfaced electrically non-conductive strip of mounting board with red and amber LEDs mounted alternately at intervals along a first side of said reflective board, and electrical connectivity for said LEDs beneath said reflective surface or coating, is placed longitudinally inside of a mold into which optically conductive acrylic or other plastic is injected. Said injection mold is constructed to form end-to-end “V” shaped longitudinal depressions into the outside facing surface of said molded acrylic first component. Triangular shapes, or any other shape or surface distortion that will diffuse light directed toward said outside facing surface from said imbedded LEDs may be also be molded.

A second component for said first embodiment of side marker light is a UVa and UVb resistant polycarbonate cover that is injection molded with an inside surface that conforms exactly to the longitudinally ribbed outside surface of said first component. The outside surface of said second component polycarbonate cover is shaped to conform to the particular vehicle panel surface contour into which it will be mounted, and said outside surface of said second component may be clear or frosted. Said second component polycarbonate cover is then ultrasonically welded onto the ribbed outside surface of said first component to form a one piece optically clear or frosted white, side marker light. Said electrical connectivity of said first embodiment of this new side marker lighting is designed to electrically connect all of the red LEDs in a series, series parallel, or parallel connection as desired. All of the amber LEDs are electrically connected in like manner.

The insertion plastic injection molding of said first component, and the injection molding of the polycarbonate cover of said second component could be a combined process that eliminates the need for ultrasonic welding or other means to combine the two components. The polycarbonate cover may remain a separate tight fitting second component that is snapped into place, glued, mechanically fastened, or held in position as a cover on said first component by any means.

A second embodiment of this instant invention utilizes a double sided reflective surfaced electrically non conductive strip of mounting board that has red and amber LEDs mounted alternately along a first side of said mounting strip, and white and/or other colored LEDs mounted along a second side of said mounting strip. The width of the opening in the vehicle side panel for said side light would be narrower than the reflective surface of the LED mounting board within said sidelight so that light from a first side of said sidelight is not visible through the illumination device from a second side, and light from a second side is not visible through the illumination device from a first side. The electrical connectivity of said double-sided strip of LEDs requires four or more electrical conductors. A first conductor would supply positive power to said outside red LEDs. A second conductor would supply positive power to said outside amber LEDs. A third conductor would supply power to said inside white LEDs. A fourth conductor would supply power to any other colored inside LEDs. A fifth and/or sixth conductors would supply common or negative to all LEDs. Said first side of said second version of this instant invention will illuminate the outer surface of said illumination device with red or amber light as required to cooperate with the vehicle lighting system, and said second side will illuminate the storage or cargo area of a truck, automobile trunk, wheel well, or engine compartment, with white or colored light when said second side LEDs are electrically powered on. Said second side may be covered permanently or temporarily by a colored plastic lens or cover to change the white inside illumination to any selectable or desired color. Said cover may use snap-fit or press fit retention, or be attached by any other means.

A third embodiment of this instant invention is formed by placing two single sided reflective LED mounting strips into an injection mold with a first strip inserted just above the bottom of the mold with the LEDs facing in an upward direction. A pre-made reflective surface is inserted into said mold that extends substantially from a first end to a second end of said mold. The reflective surface bottom side or edge is placed toward the back of the mold beyond the back edge of said first LED mounting strip. The topside of said reflective surface is positioned toward the front of said mold. A second LED-mounting strip with the LEDs facing in a downward direction is inserted just below the top of the mold and behind the top edge of the reflective strip. The diagonal placement of the reflective surface causes illumination from the bottom mounted LEDs to reflect in a forward direction, and illumination from the top mounted LEDs to reflect in a back direction. i.e. Light from the bottom LED strip aimed in an upward direction will be reflected generally at a right angle toward the front surface of this first component, and light aimed in a downward direction from said second LED mounting strip will be reflected generally at right angles to the source toward the back surface of said first component.

One or more individual LEDs, or cluster LEDs, may then be inserted into said mold, at one or more ends of said mold, facing toward the opposite end of said mold. Said one or more LEDs are placed beneath the ends of the top LED-mounting strip and above the ends of the bottom LED-mounting strip. End light from said individual or cluster LEDs will be directed out of said first component as side light by said reflective surface. Optically conductive acrylic or other plastic is then injected into said mold locking all of said LED components, electrical conductors, and said reflector into position. Said mold will create rows of V shaped illumination diffusing indentations from end to end on the front surface of said first component.

In vehicle panel locations where the first or second embodiment of this sidelight instant invention cannot be completely mounted between an inner and outer panel of the vehicle wall, or the wall is a single panel, such as a fender wall over a wheel well, an inside bracket or housing may be required to support said side light. Said inside support bracket will require an elongated opening to allow illumination from said back surface of said second version said side light to be visible.

The first embodiment of this instant invention as described in the objective of the invention is used as a new two-color side marker light system mounted within an elongated cavity or opening in a vehicle sidewall or panel. This acrylic illumination device would be mounted within the cavity so that the outer illumination device surface would be flush or nearly flush with the outer surface of the vehicle side panel and conform to the shape or contour of said panel. The illumination of the amber and red LEDs would cooperate with the vehicle illumination system in a manner consistent with the National Highway Traffic Safety Administration Federal Motor Vehicle Standard No. 108.

The second embodiment of this instant invention is mounted within a side wall of a pick up truck cargo area so that a first side of said combination illumination device is approximately flush with the outside panel, and a second side of said combination illumination device is approximately flush with the inside panel or wall of said cargo area. Said first side of said illumination device would cooperate with said vehicle signal lights and said second side would be electrically switch controlled to illuminate the cargo area of said truck with white light not visible through said illumination device from the outside of said truck.

The second or third embodiment of said illumination device can be mounted into the sidewall of an automotive vehicle above a wheel well. The outside section of said combination illumination device would function as a combination amber running light and turn signal light, and the inside section of said combination illumination device would function as a switch controlled side marker light/turn signal light, or wheel well illumination white light for maintenance or repair of the wheel at night.

Said second or third embodiment of this instant invention can be mounted into the sidewall of a vehicle motor hood. Said hood is designed with a nearly vertical section of sidewall not visible to the motor vehicle operator. The outer side of said combination illumination device functions as a combination side marker/signal lamp and the inner side functions as a switch controlled engine area illuminator or night trouble light.

An U.S. DOT interpretation of Federal Motor Vehicle Standard 108 states that additional amber side marker lights that function as secondary directional signal lights on vehicles equipped with OEM red directional lamps, flash additional side marker directional lamps in a manner consistent with the OEM red lamps, and that is to extinguish the amber light in said side marker lamp and flash said lamp red/off, red/off. Motor vehicles with amber OEM directional lamps are required to flash said secondary directional lamps amber/off, amber/off. Said additional side marker lamps mounted on the rear quarter of a vehicle may extinguish their amber running light color and illuminate red with the red vehicle OEM brake lights. This instant invention will comply with said U.S.D.O.T-F.M.V.S 108 by utilizing newly designed electrical circuits not disclosed herein.

### BRIEF DESCRIPTION OF THE DRAWINGS

FIG. 1 is a left side elevational view showing preferred embodiments of the invention installed in four different locations in the sidewall of a pick up truck.

FIG. 2A is an exploded perspective view of first component A of a first embodiment of the invention.

FIG. 2B is an exploded perspective view of a second component B of a first embodiment of the invention.

FIG. 2C is a magnified perspective view of a center cut away of joined components A and B of the first embodiment of the invention mounted into and behind a vehicle side wall.

FIG. 3A is an exploded perspective view of first component C of a second embodiment of the invention.

FIG. 3B is an exploded perspective view of second component D of a second embodiment of the invention.

FIG. 3C is an exploded perspective view of third component E of a second embodiment of the invention.

FIG. 3D is a magnified perspective view of a center cut away of joined components C, D, and E of the second embodiment of the invention mounted between a double panel vehicle sidewall.

FIG. 4 is a magnified perspective view of a center cut away of a third embodiment of the invention mounted between a double panel vehicle sidewall.

### DETAILED DESCRIPTION OF THE PREFERRED EMBODIMENTS

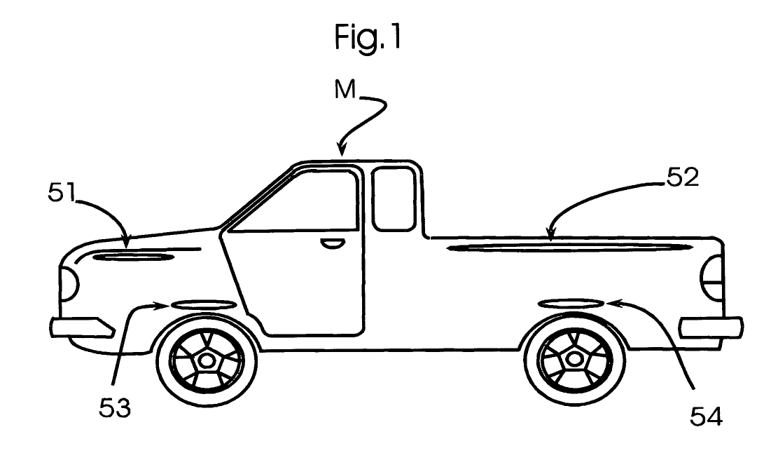

The present invention is an optical conductor illumination device for use with motor vehicle M of FIG. 1. As shown if FIG. 1 the illumination device 52 can be long in length and mounted into the truck sidewall below the bed rail, or shorter in length and mounted into the vehicle side wall 54 above the rear wheel, or mounted into the front fender sidewall 53 above the front wheel, or into the vehicle engine hood sidewall 51.

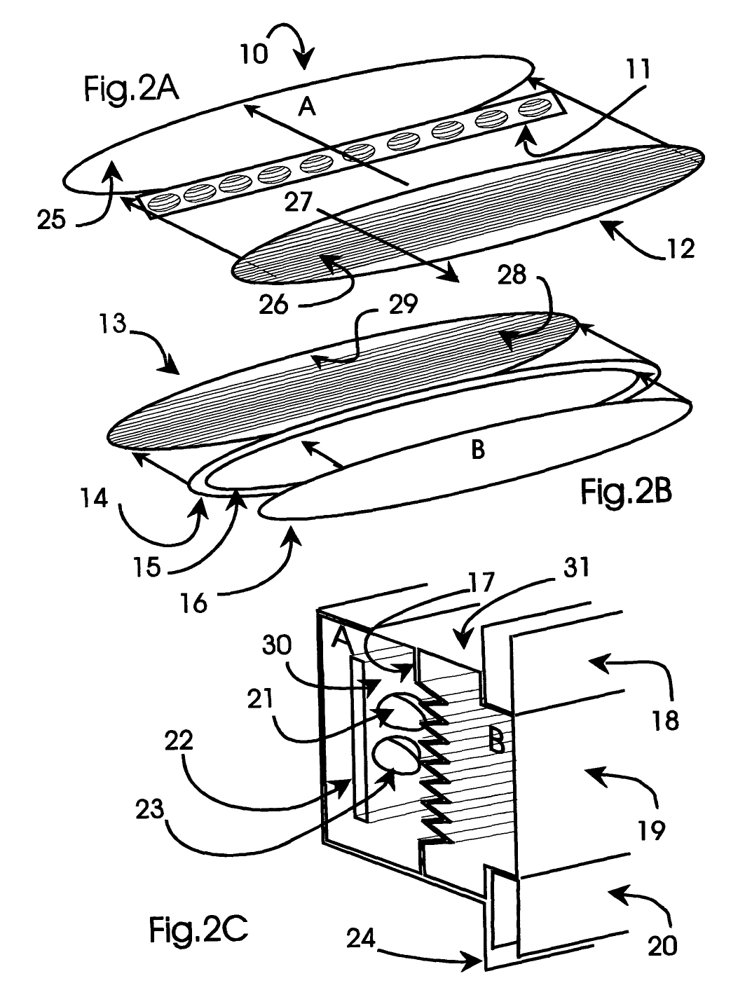

As shown in 10 of FIG. 2A, an exploded view of a first component 10 of the first embodiment of the invention is comprised of an LED reflective board mounting strip 11 with LEDs facing in a forward direction 27 inserted into an optically conductive component 10 with a flat back surface 25 and a front surface 12 comprised of full length longitudinal groves 26 or other illumination diffusing means such as frosting of surface 12.

FIG. 2B discloses an exploded view of second component 13 of said first embodiment. Said second component 13 is a UV resistant polycarbonate cover with full length elongated groves 28 on inside surface 29 that match identically said groves 26 on said first component front surface 12. Surface 14 is the same size and shape as back inside surface 29, and depicts a certain small depth of the depicted size before the size decreases as depicted by surfaces 15 and 16.

FIG. 2C discloses a magnified cut away end perspective view of a first embodiment 31 of this invention. Insertion plastic injection molded first component 10 of FIG. 2A, and injection molded polycarbonate cover 13 of FIG. 2B, are ultrasonically welded together at 17 where their illumination diffusing ribs interlock. An end view of reflective surfaced 30 LED mounting strip 23, with alternately located red LEDs 21, and yellow LEDs 23, that has been insertion molded into said first component 10 of FIG. 2A is shown. Back mounting and support bracket 24 holds said first embodiment 31 in position so that outside facing surface 19 is approximately flush with upper vehicle outside panel surface 18, and lower outside vehicle panel surface 20.

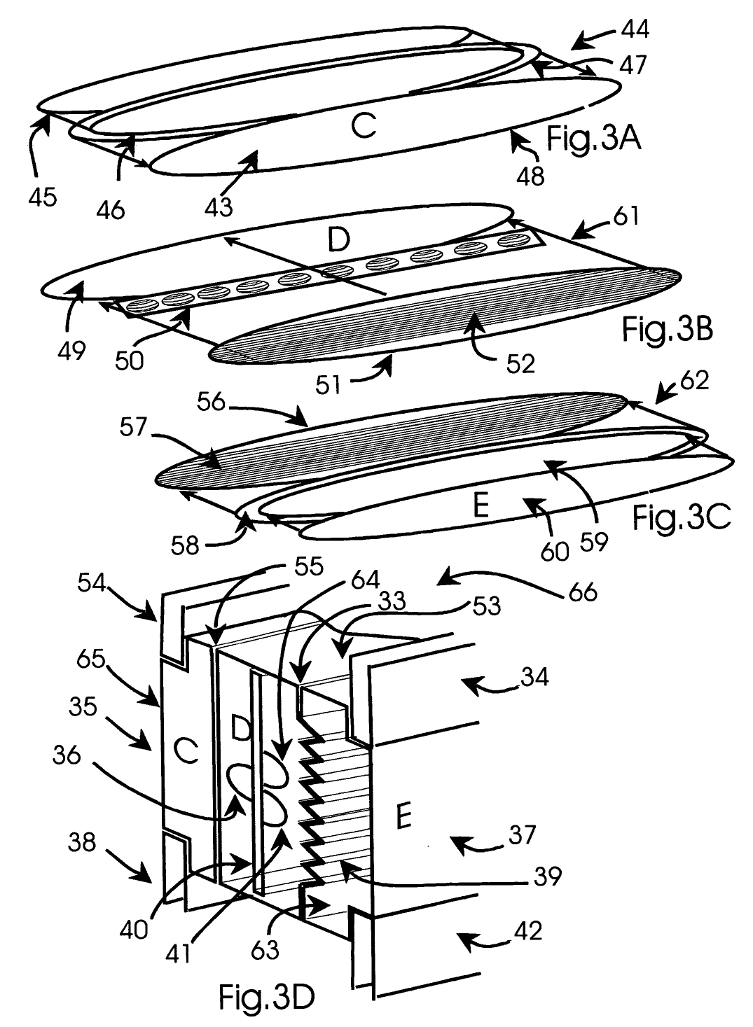

FIG. 3A is an exploded view of a first plastic injection molded clear polycarbonate cover component 44 of a second embodiment of the invention. Surfaces 45 and 46 depict the smaller section of said first component and surfaces 47 and 48 depict the larger part of said first component.

FIG. 3B depicts an exploded view of an insertion injection molded optically conductive second component 61 of said second embodiment with inserted LED mounting board 50 of said second embodiment. Clear surface 49 is ultrasonically welded to FIG. 3A clear surface 43. Second surface 51 depicts illumination diffusing longitudinal end-to-end V shaped or other shaped illumination diffusing means 52.

FIG. 3C is an exploded view of a third injection molded clear polycarbonate cover component 62 of said second embodiment. Inner surface 56 displays longitudinal illumination diffusing V shaped indentations 57 or other illumination diffusing means that mirror the illumination means 52 of surface 51 of FIG. 3B. Surface 58 is the same size and outer shape as surface 56. Smaller size surfaces 59 and 60 depict the smaller outer section of said third cover component.

FIG. 3D is a magnified cut away end perspective view of a second embodiment 66 of this invention. Said second embodiment is comprised of a first component 35 ultrasonically welded to a second component 53 at junction 55, and a third component 63 ultrasonically welded to said second component at junction 33. Said second embodiment 66 is mounted between inner vehicle sidewall panel 54 and 38 and an outer vehicle sidewall panel 34 and 42. Led mounting board 40, with outside facing alternating red LEDs 41, yellow LEDs 64, and inside facing white LEDs 36, is shown disposed within said second component 53. Longitudinal illumination diffusing means is located at ultrasonically welded joint 33. Inside surface 65 is mounted approximately flush with inside wall panel 54 and 38, and outside surface 37 is mounted approximately flush with outside panel 34 and 42.

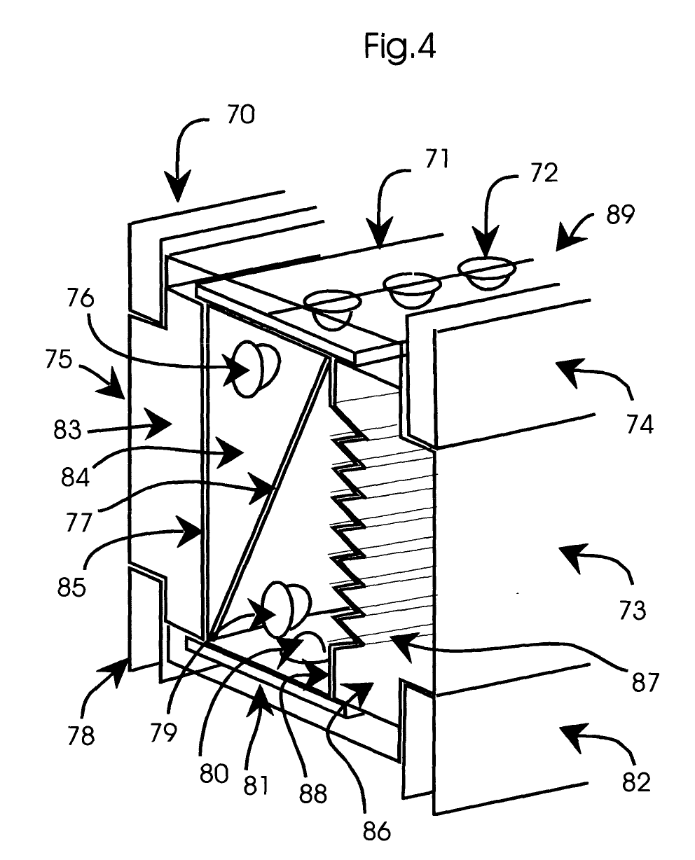

FIG. 4 is a magnified cut away end perspective view of a third embodiment 89 of this invention. Said third embodiment is comprised of first component 83 ultrasonically welded to second component 84 at junction 85, and third component 86 ultrasonically welded to said second component 84 at junction 88. Said third embodiment 89 is mounted between inner vehicle sidewall panel 70 and 78 and vehicle outer sidewall panel 74 and 82. Longitudinal diagonally placed double sided reflective surface 77, extending from a first end to a second end of said second component, is disposed within said second component 84 from bottom left to top right as viewed in this left side cut away end view of said second embodiment 89. Top positioned LED mounting board 71 is disposed within said third embodiment 89 above said reflective surface 77 so that downward directed illumination from LEDs 72 will be reflected by said reflective surface 77 toward inside surface 75 of said embodiment 89. Illumination from LED 76 disposed within the end of said second component 84 will also be reflected toward inside surface 75 of said embodiment 89. Illumination from LEDs 80 on bottom mounted LED board 81 is directed upward and reflected in a forward direction through light diffusing means 87 and through outside surface 73. Bottom end-mounted LED 79, disposed within the end of said second component 84, will also be reflected in a forward direction through light diffusing means 87, and through outside surface 73.

It is understood that the present invention is not limited to the embodiments described above, but encompasses any and all embodiments within the scope of the following claims.

1. A motor vehicle illumination device comprising:
a least a first assembly and at least a second component;
A) said first assembly including:
a) at least one inserted injection plastic or acrylic molded component;
i) said plastic or acrylic to be optically clear, optically opaque or color tinted;
b) said inserted injection plastic or acrylic component containing at least one inserted multiple light emitting diode mounting board with multiple light emitting diodes, or LEDs, mounted on at least a first side;
i) said light emitting diodes to be at least a first color and or a second color;
ii) said first color to be amber and said second color to be red;
iii) said light emitting diode mounting board positioned within the insertion injected component to direct illumination from said light emitting diodes toward a first side surface of said insertion injected component;
iv) said light emitting diode mounting board to have an illumination reflective surface on at least a first side;
c) electrical connectivity for said multiple light emitting diodes is installed beneath said illumination reflective surface on said LED mounting board;
d) said inserted plastic injected component having illumination diffusing means on at least a first side;
i) said illumination diffusing means to include at least multiple approximate end to end, or top to bottom, “V” shaped indentations, or any other shaped surface distortions intended to diffuse illumination, or chemical, gas, or mechanical frosting of at least said a first side;
B) said second component comprised of at least a first injection molded UV resistant polycarbonate cover for said first component;
a) said polycarbonate cover formed with a first side to fit against the complete said first side surface illumination diffusion means of said first assembly component;
i) said polycarbonate cover second side formed to fit into an opening in the outside surface of a motor vehicle and to conform to the outside surface contour of said motor vehicle side or other panel;
ii) said polycarbonate cover second side may be optically clear, opaque, or frosty;
b) said first insertion injected plastic or acrylic assembly component may be fastened to said second component polycarbonate cover by means including but not limited to ultrasonic welding, where the illumination diffusion means of said first component first side, joins the illumination diffusion means of said second component first side;
c) said second component polycarbonate cover may remain a tight fit to said first component and be secured in place against said first component by snap-fit retention, mechanical fasteners, or other fastening means;
d) said ultrasonic welding together of said first assembly and said second component form a first embodiment of said motor vehicle illumination device intended to be mounted between an inner and outer panel of a double paneled motor vehicle, or mounted inside of a single panel vehicle;
e) said vehicle outer panel to have an elongated opening that the outer said second side of said polycarbonate cover fits into from the inside, but not through.

2. The motor vehicle illumination device according to claim 1, where said at least a second component includes a third component;
a) said third component is an injection molded UV resistant polycarbonate cover with a first side clear surface that matches in size and shape the second side of said first insertion injection molded component of claim 1;
i) said polycarbonate cover may be optically clear, opaque, or colored;
b) said first side clear surface of said third component may be secured by ultrasonic welding or any other means to said second side surface of said first insertion injection molded component of claim 1;
c) said third component polycarbonate cover may remain a tight fit against said second side of said first insertion injection molded component of claim 1, secured in place by snap fit retention, mechanical fasteners, or any other means;
d) said second side of said third component is reduced in size from said first side of said third component to fit into but not through an opening in a vehicle inner wall, such as the inner wall of a pick up truck or other truck body;
e) said combination of components described in claim 1 and claim 2 form a second embodiment of this instant invention;
i) said combination of components may be accomplished by a co-extrusion process whereby said two or more extruded components are joined as they are formed;
f) said second embodiment may be mounted between a vehicle double side panel or behind a vehicle single side panel;
i) said single side panel mount requires one or more mounting brackets to secure said second embodiment in place;
ii) said one or more brackets require an opening through which illumination from said second embodiment is visible;
g) said inserted multiple light emitting diode mounting board of claim 1 to be illumination reflective on a first and on a second side;
i) said light emitting diode mounting board to have light emitting diodes mounted on a first and on a second side of said board;
ii) said light emitting diodes on said second side of said board to face away from said board to direct illumination toward and through said third component;
iii) said light emitting diodes on said second side of said mounting board to be at least a first color;
iv) said first color is white.

3. The motor vehicle illumination device according to claim 1, where said insertion plastic injection molded component contains a first and a second multiple light emitting diode mounting boards;
a) said first LED mounting board is positioned in said inserted plastic injection mold near the top, with said LEDs facing downward, and said second LED mounting board is positioned in said injection mold near the bottom with said LEDs facing up;
i) said LED mounting boards are optically reflective on the LED mounting side;
b) additional individual or cluster LEDs are inserted into said injection mold positioned to direct illumination from at least a first end of said insertion injected molded component toward a second end;
c) a double sided optically reflective means is positioned diagonally in said mold, substantially from a first end of said mold to a second end of said mold, so that illumination from the downward directed LEDs of said first mounting board is reflected out of said second side of said insertion injected component, and illumination directed upward from said second LED mounting board is reflected out of said first side of said insertion injected component.

4. Said optically clear UV resistant polycarbonate cover of claim 2 may have an extended lip or edge for snap-fit retention, or other anchoring means, for one or more removable colored lenses.
